(19) United States
(12) Patent Application Publication
(10) Pub. No.: US 2001/0012285 A1
(43) Pub. Date: Aug. 9, 2001

(54) INTERNET-TELEPHONE INTERFACE SYSTEM

(75) Inventors: DAVID SHAHARABANI, RAMAT-GAN (IL); TZACHI BEN GAL, RAMAT-GAN (IL)

Correspondence Address: MERCHANT & GOULD, P O BOX 2903, MINNEAPOLIS, MN, 55402-0903, US

(73) Assignee: MASHOV TELECOM LTD., OR-YEHUDA (IL)

(21) Appl. No.: 08/934,793

(22) Filed: Sep. 22, 1997

(30) Foreign Application Priority Data
Aug. 3, 1997 (IL) 121454

(51) Int. Cl. H04L 12/56

(52) U.S. Cl. 370/352; 370/401

(57) ABSTRACT

An Internet-telephone interface system is disclosed. The system provides a fully integrated system that permits the transfer of calls received over the Internet to the regular telephone net, and vice versa. Calls may be made via the regular telephone system or the Internet. The system includes an adapter for creating telephone signals based upon input signals, the adapter selectively coupling a microphone and speaker system with a telephone line and a computer using the created telephone signals based upon the source of the input signals. The input signals are from a telephone line and the adapter couples the microphone and speaker system to the telephone line. The input signals from the computer are signals from a sound device in the computer. The adapter may also include a switch for switchably controlling a connection to the microphone and speaker system, wherein the connection comprises a first connection between the microphone and speaker system and the computer and a second connection between the microphone and speaker system and the telephone line. A microprocessor is provided for controlling functions of the adapter.

### BACKGROUND OF THE INVENTION

1. Field of the Invention

This invention relates in general to computer-telephone integration (CTI), and more particularly to an interface between computer systems, such as the Internet, and the regular telephone system.

2. Description of Related Art

With the expansion of the Internet, the potential for inexpensive telecommunications has been recognized using the low-cost Internet data transmission and the readily available PC power found virtually in every home in the westerns world. Many solutions have been provided in the art, during a relatively short period of time, for allowing voice communication over the Internet using special software and either a PC sound device, such as a sound card, a microphone and speaker or, a handset of a regular telephone as a microphone and speaker. One such commercial system is manufactured by Solram Electronics Ltd., Israel, under the name “Interhome SE-T100E”. Another similar product is manufactured by ITI USA, Inc., under the name “CompuPhone 2000”. A review of such techniques by Robert E. Calem was recently published (Jun. 7, 1997) in the New York Times “CyberTimes” section, under the title “Internet Telephones in the Image of Real Phones”.

Although prior art devices make it possible to communicate through the Internet using a regular phone connected to a PC, they do not provide real computer-telephone integration. Such real CTI is necessary, as will be better understood from the description to follow, if the connection between the computer between the and the telephone system is to be effectively exploited in a variety of systems, such as the Internet or an intranet. The lack of real integration of the present art is a substantial disadvantage, because talking over the Internet still remains a task that requires special arrangements, connections and computer skills, and therefore the use of Internet telephone, e.g., in large organizations which use telephone systems with a plurality of users, remains limited.

It is therefore clear that there is a need for fully integrating the computer telephone power into regular telephone systems.

It can be seen then that there is a need for a system and apparatus that permits the transfer of calls received over the Internet to the regular telephone net, and vice versa.

It can also be seen that there is a need for a system and apparatus that allows calls to be made via the regular telephone system or the Internet.

It can also be seen that there is a need for a system and apparatus for integrating Internet telephone activities into regular telephone activities.

### SUMMARY OF THE INVENTION

To overcome the limitations in the prior art described above, and to overcome other limitations that will become apparent upon reading and understanding the present specification, the present invention discloses an Internet-telephone interface system.

The present invention solves the above-described problems by providing a fully integrated system that permits the transfer of calls received over the Internet to the regular telephone net, and vice versa. Calls may be made via the regular telephone system or the Internet.

A system in accordance with the principles of the present invention includes an adapter for creating telephone signals based upon input signals, the adapter selectively coupling a microphone and speaker system with a telephone line and a computer using the created telephone signals based upon the source of the input signals.

Other embodiments of a system in accordance with the principles of the invention may include alternative or optional additional aspects. One such aspect of the present invention is that the input signals are from a telephone line and the adapter couples the microphone and speaker system to the telephone line.

Another aspect of the present invention is that the input signals from the computer are signals from a sound device in the computer.

Another aspect of the present invention is that the microphone and speaker system comprises a speaker and microphone coupled to the sound device.

Another aspect of the present invention is that the adapter converts digital signals received via the Internet at the sound device to analog telephone signals.

Another aspect of the present invention is that the input signals are from the computer and the adapter couples the microphone and speaker system to the computer.

Another aspect of the present invention is that the microphone and speaker system comprises a telephone.

Yet another aspect of the present invention is that the created telephone signal comprises a ring signal, a dial tone, and a busy tone.

Another aspect of the present invention is that the created telephone signals further comprise control signals for performing a call transfer.

Another aspect of the present invention is that the control signals establish a virtual line for performing the call transfer.

Another aspect of the present invention is that the created telephone signals further comprise a call waiting signal indicating an incoming call.

Another aspect of the present invention is that the adapter further comprises a switch for switchably controlling a connection to the microphone and speaker system, wherein the connection comprises a first connection between the microphone and speaker system and the computer and a second connection between the microphone and speaker system and the telephone line.

Another aspect of the present invention is that the adapter further includes a detector for detecting a call signal, said call signal being representative of a telephone apparatus trying to establish connection with the microphone and speaker system, a telephone ring generator for generating a telephone ring signal for signaling the detection of the call signal and an off hook detector for detecting off hook status of the microphone and speaker system, wherein the switch connects the microphone and speaker system to the computer upon detection of the off hook status.

Still another aspect of the present invention is that the adapter further comprises a ringing signal generator for transmitting to a calling party a signal indicative that a called party has not answered the call while the off hook status is not detected.

Another aspect of the present invention is that the detector for detecting a call signal further comprises a DTMF receiver, the DTMF receiver translating DTMF signals to digital signals for processing by the adapter.

Another aspect of the present invention is that the adapter further comprises a conference call system for connecting a plurality of communications lines to create a conference call.

Another aspect of the present invention is that the adapter further comprises a hold circuit for holding a first call while a second call is processed.

Another aspect of the present invention is that the adapter further comprises an on-hold music circuit for generating music when a call is being held hold.

Another aspect of the present invention is that a microprocessor is provided for controlling functions of the adapter.

These and various other advantages and features of novelty which characterize the invention are pointed out with particularity in the claims annexed hereto and form a part hereof. However, for a better understanding of the invention, its advantages, and the objects obtained by its use, reference should be made to the drawings which form a further part hereof, and to accompanying descriptive matter, in which there are illustrated and described specific examples of an apparatus in accordance with the invention.

### BRIEF DESCRIPTION OF THE DRAWINGS

Referring now to the drawings in which like reference numbers represent corresponding parts throughout:

FIG. 1 illustrates an improved telephone apparatus according to one embodiment of the invention;

FIG. 2 shows an alternative embodiment of the improved telephone of FIG. 1;

FIG. 3 shows one possible configuration of a CTI system according to a preferred embodiment of the invention when used in conjunction with a network such as the Internet or an intranet;

FIG. 4 illustrates a block diagram of the interface;

FIG. 5 illustrates the electronic structure of the interface adapter of FIG. 4;

FIG. 6 illustrates the power supply circuit;

FIG. 7 illustrates the microcomputer;

FIG. 8 illustrates the integration of the telephone and computer systems;

FIG. 9 shows the circuitry of the floating square wave ringing generator;

FIG. 10A shows the zeroing procedure of the system;

FIG. 10B shows the update procedures for the various registers as a function of the detection of the status of the communication line;

FIG. 10C shows the ring detection procedure;

FIG. 10D shows the procedure for ring generation;

FIG. 10E shows the procedure used to provide a beep signal to the earphone;

FIG. 10F shows the routine that takes care of the on-hook/off-hook status, and which updates the relevant registers as a result of the current status;

FIGS. 11A-11B illustrate a routine which analyzes the DTMF coming from either the telephone or the Internet to determine whether it is the appropriate signal, and whether it is accompanied by noise;

FIG. 12 shows a configuration in which a plurality of improved telephone apparatuses are connected in parallel on the same line;

FIG. 13 illustrates a possible connection setup using the apparatus of the invention; and

FIG. 14 illustrates another setup utilizing the invention, which is suitable for communication between two organizations via the Internet or an intranet.

### DETAILED DESCRIPTION OF THE INVENTION

In the following description of the exemplary embodiment, reference is made to the accompanying drawings which form a part hereof, and in which is shown by way of illustration the specific embodiment in which the invention may be practiced. It is to be understood that other embodiments may be utilized as structural changes may be made without departing from the scope of the present invention.

The present invention provides an Internet-telephone interface system for need for fully integrating the computer telephone power into regular telephone systems. The system permits the transfer of calls received over the Internet to the regular telephone net, and vice versa. Calls may be made via the regular telephone system or the Internet.

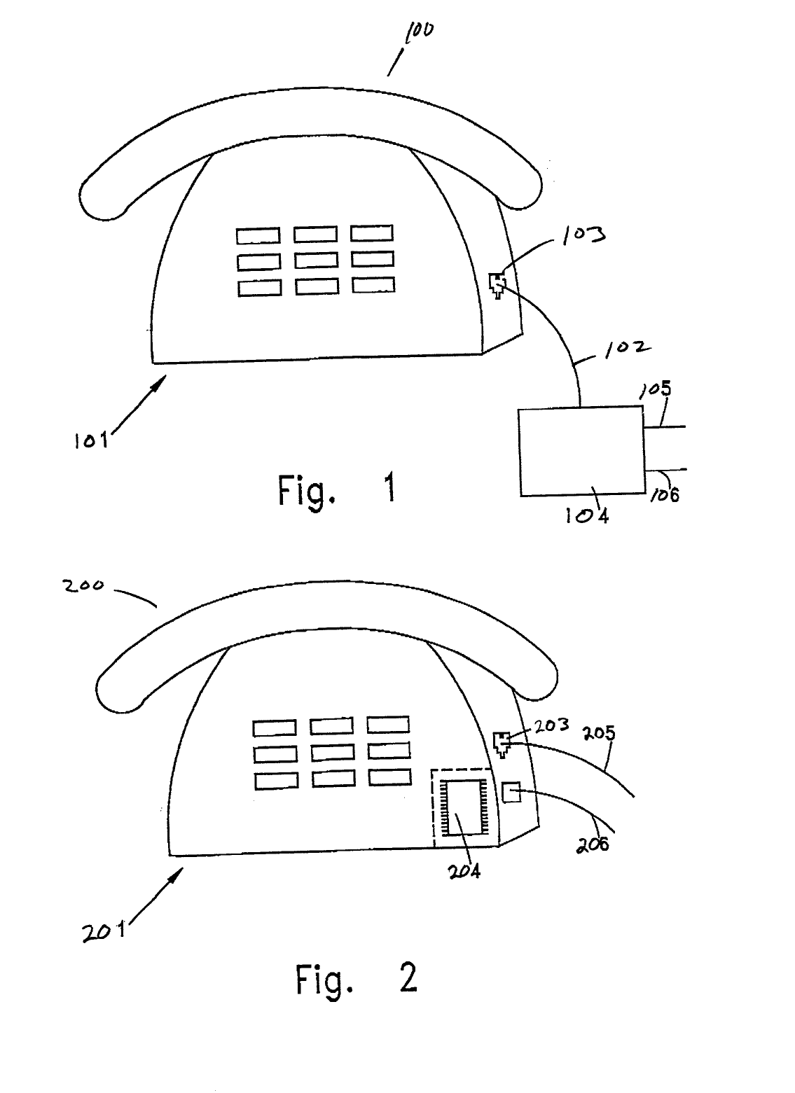

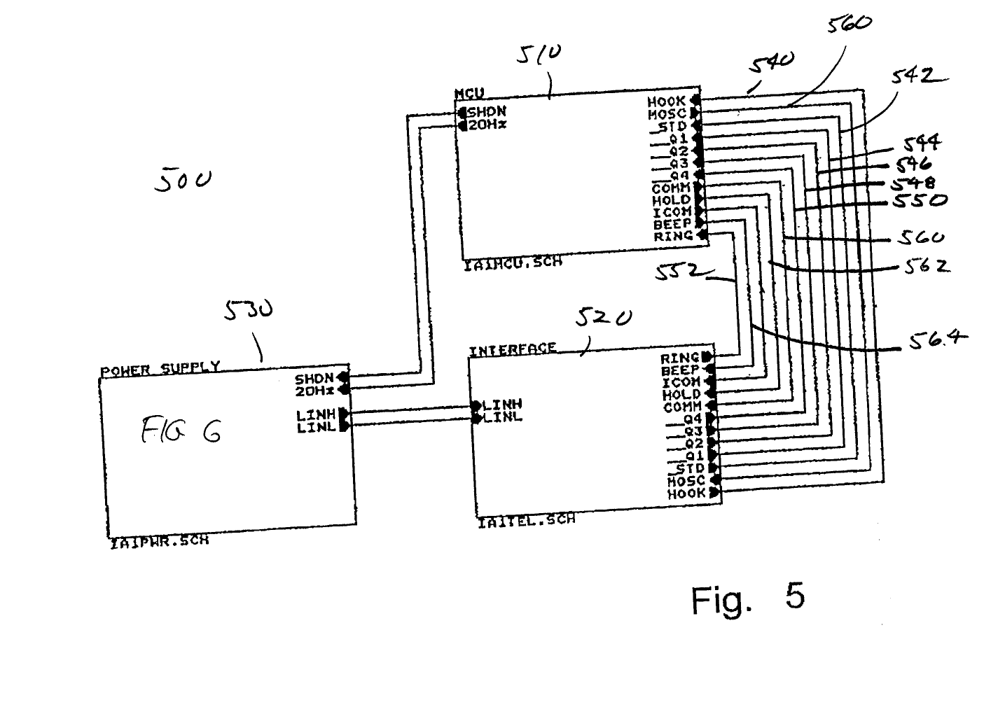

FIG. 1 schematically shows an improved telephone apparatus 100 according to one embodiment of the invention. In this alternative, a regular telephone apparatus, generally indicated by numeral 101, is connected to a line 102 via socket 103. Line 102 reaches interface means 104 (described below in detail with reference to FIGS. 5-9) to which there are connected two lines, 105 and 106. One of lines 105 and 106 is a regular telephone line, and the other is a line coming from a sound device in a computer, such as a sound card or other device which provides audio capabilities. Interface 104 is capable of switching between lines 105 and 106, or to connect between them so as to create a conference call between them and the person using telephone 101. The interface 104 is explained in greater detail below.

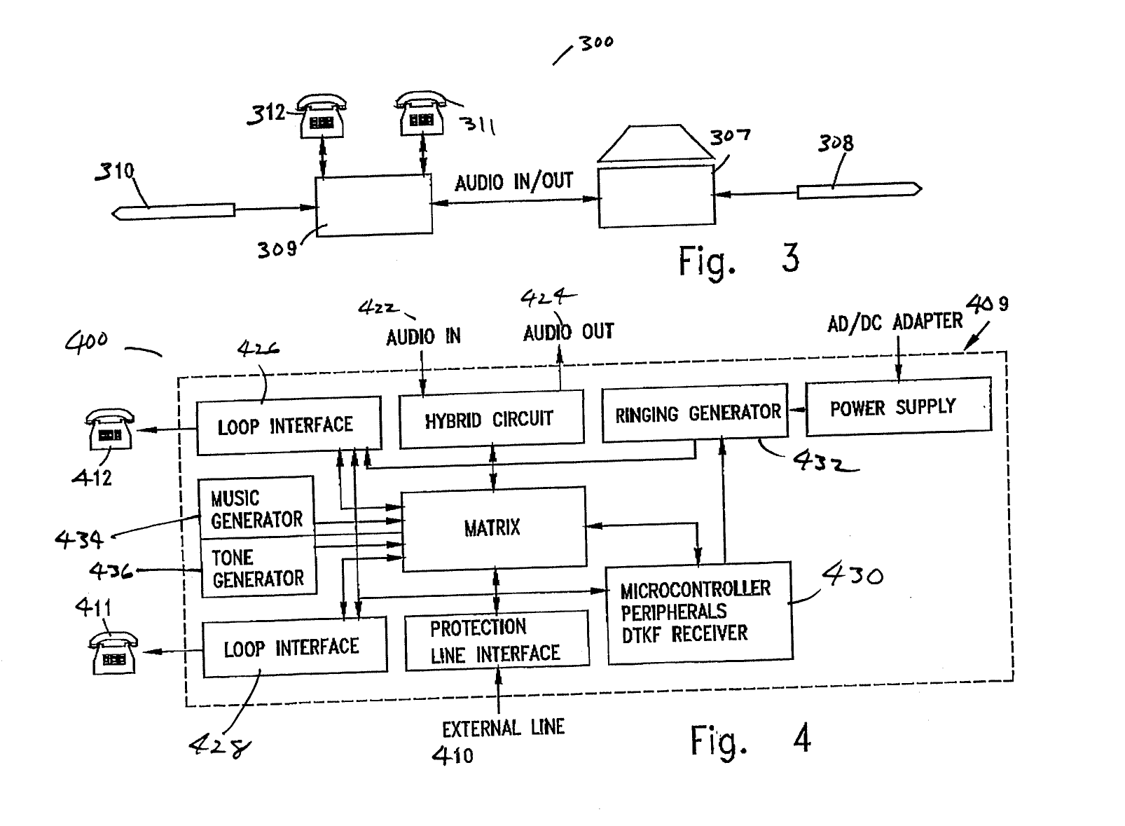

FIG. 2 shows an alternative embodiment 200 of the improved telephone of FIG. 1. The functional elements are the same, but the interface adapter 204, shown in broken lines in FIG. 2, is made integral with the telephone apparatus.

FIG. 3 shows one possible configuration of a CTI system 300 according to a preferred embodiment of the invention, when used, e.g., in conjunction with a network such as the Internet or an intranet. A computer 307 provided with audio in/out circuitry (e.g., a sound card) is connected to the network via a first external line, indicated by numeral 308. Audio signals encoding speech received over the Internet is fed via the audio card to interface adapter 309, which is also connected to a second outside line 310. Interface 309 is connected to conventional telephone means, either by providing two separate telephones as shown in FIG. 3, where telephone 311 is connected to the network line and telephone 312 is connected to the external line, or by using a single telephone apparatus, as shown in FIG. 1 or in FIG. 2.

The operation of the interface is explained in the block diagram 400 of FIG. 4. The adapter 409 includes a port 420 for providing power to the electronics of the adapter 409. The adapter 409 includes ports providing audio input 422 and output 424 signals for connecting to a sound device such as a computer sound card. The adapter 409 is also connected to a second outside line 410. Interface 409 is connected to conventional telephones 411, 412 via the loop interfaces 426, 428, where telephone 411 is connected to the network line and telephone 412 is connected to the external line, or by using a single telephone apparatus, as shown in FIG. 1 or in FIG. 2. A microcontroller 430 controls the operation of the adapter. The adapter includes a ring generator 432 for generating an audio indication of incoming calls. A music generator 434 is provided for generating music when calls are place on hold and a tone generator 436 provides audio tones for simulating dial tone, ringing tone and busy tones, or for generating a warning sound to alert a person conducting a telephone conversation, of a further incoming call, i.e. call waiting. Many other options can be added, as will be apparent to the skilled person, which are understood by the man of the art and which, therefore, are not discussed herein in detail, for the sake of brevity.

The electronic structure 500 of the interface adapter of FIG. 4 is schematically shown in FIG. 5. MCU 510 is the microcomputer that functions as the logic controller that operates the interface adapter 520. The interface adapter 520 deals with the telephone activities, as further explained hereinafter. The power supply 530 supplies power to drive the adapter 520 and microcontroller 510.

The interface adapter 520 provides a hook state signal 540, a valid DTMF receiver data indicating signal 542, four DTMF receiver data signals 544-550, and a line ring signal detection signal 552 to the processor 510. The processor 510 provides a clock signal for the DTMF receiver 560, the Internet/line select signal 560, the music on hold signal 562, the audible signal tone and the line ring signal detection signal 564 to the interface adapter 520.

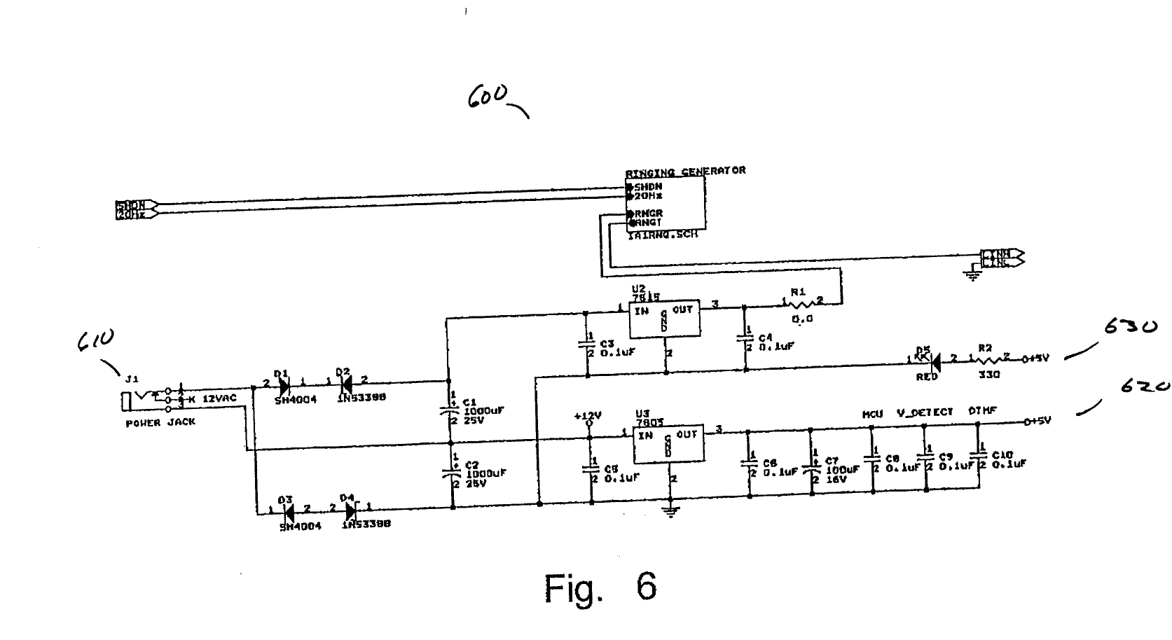

The power supply circuit 600 is shown in greater detail in FIG. 6. The functioning of the circuit is self-evident to the skilled person and, therefore, it is not described herein in detail, for the sake of brevity. It should be noted that the circuit receives 12 volts DC at the power jack 610 and provides two voltages: 5 V 620 for the logic circuitry, and 15 V 630 for the circuitry which deals with telephone functions, for the generation of a virtual telephone line.

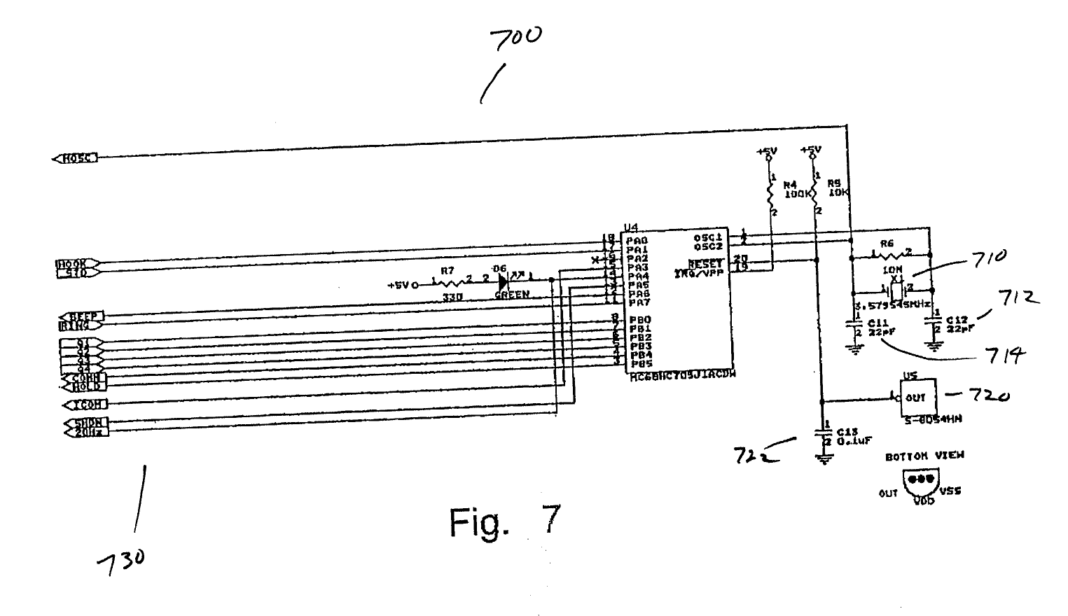

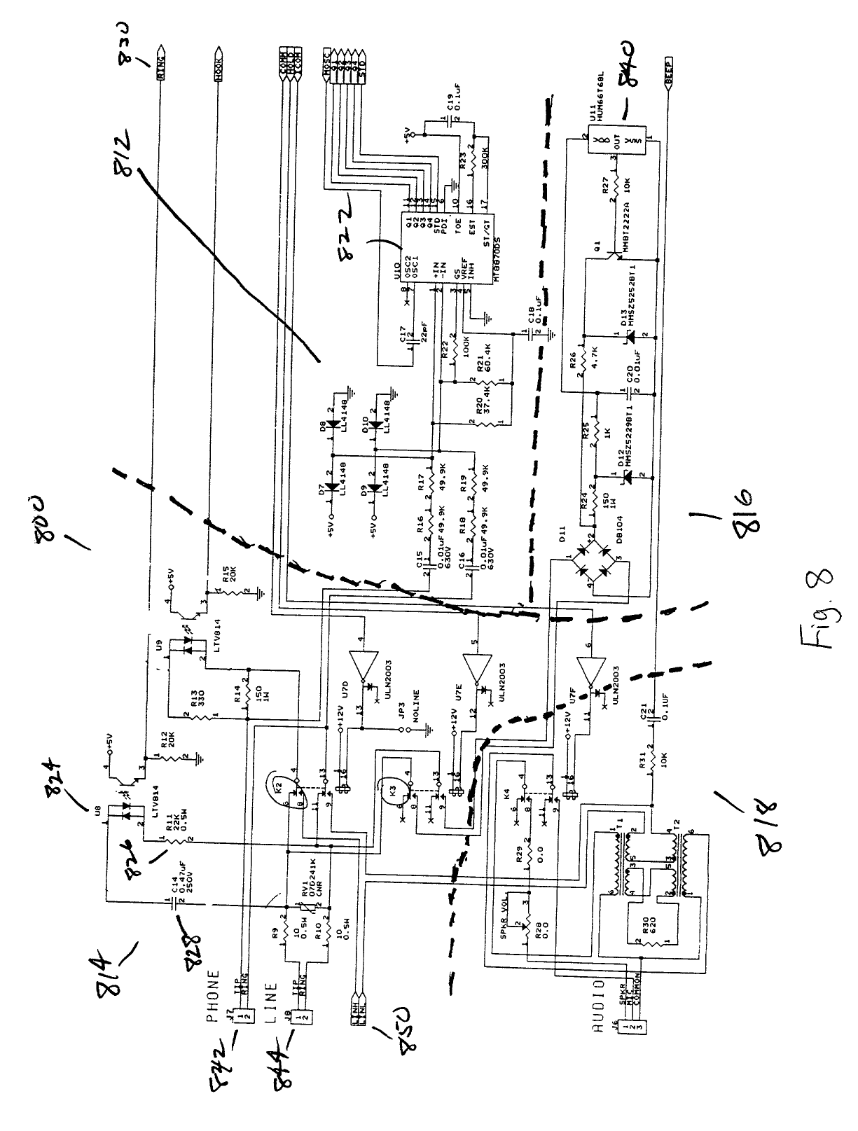

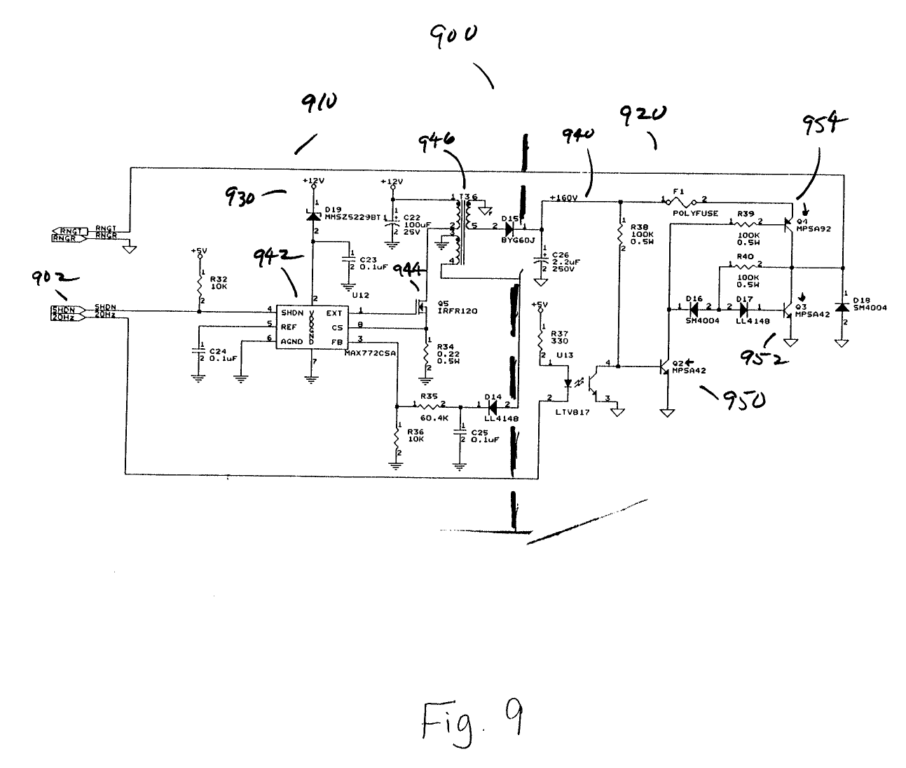

The microcomputer 700 is shown in greater detail in FIG. 7. It should be noted that X1 710, C12 712 and C11 714 operate as a resonator which generates a central clock for the processor 700 and for the DTMF receiver in the interface adapter (not shown). U5 720 and C13 722 are used to generate a reset signal each time that a potential is applied to the system, viz., at each start activity. The input/output signals 730 have been discussed above with reference to FIG. 6.

FIG. 8 schematically illustrates a schematic of the interface adapter 800 showing the integration of the telephone and computer systems. It creates the interface between the audio card of the computer and the telephone apparatus. This part of the system, shown in FIG. 8, transforms the digital signal reaching the audio card into an analog signal, which can be interpreted by the handset. In FIG. 8 the circuit is schematically divided into four different modules 812, 814, 816, 818. While the circuitry shown herein is understood by the skilled person, some key elements will be described below, with reference to the various modules.

The first module 812 is the DTMF receiver circuit which translates DTMF signals to digital signals which are passed on to the microprocessor. The DTMF receiver includes an integrated DTMF receiver U10 822 for providing the DTMF translation functions.

The second module 814 is the ring detection circuit. The ring detection circuit includes elements optocoupler U8 824, resistor R11 826, and capacitor C14 828 for the detecting the ring signal received from the outside telephone line, and for passing it on to the microprocessor as a digital signal via the ring signal output 830. LTU814 and optocoupler U9 are used to detect the on/off hook status of the telephone apparatus, which is passed to the processor via hook status signal. Relays K2 and K3 are used for various switching, such as for introducing music to the earphone during waiting periods and resistors R9, R10 and RV1 are used to protect from transient voltage.

The third module 816 is the music generator which is used to generate music or other audio signal during waiting periods. The third module includes a melody generator U11 840 for generating the on hold music.

The fourth module 818 transforms the two couples (4W) 842, 844 from the audio card, which exit at the in/out ports into 2W 850 for the telephone line. It further provides galvanic isolation between the computer and the interface card.

FIG. 9 schematically shows the circuitry of the floating square wave ringing generator 900. This circuitry starts operating when the SHDN signal 902 goes low and the frequency and cadence of the rings are set by 20 Hz signal. This circuitry can be divided into two main parts 910, 920. The first part 910 is a flyback power supply that converts the 12 V DC 930 to 160 V DC 940, and is based on current mode converter U12 942, switch Q5 944 and flyback transformer T3 946. The second part 920 passes the 160 V DC 940 through switches Q2-Q4 950-954 to form a square wave AC signal of 160 Vp-p. This voltage is superimposed on the 15 V DC from the power supply and applied to the output, so that when the telephone is lifted off-hook a DC current will identify the off-hook status and SHDN 902 will go high and shut down the circuitry.

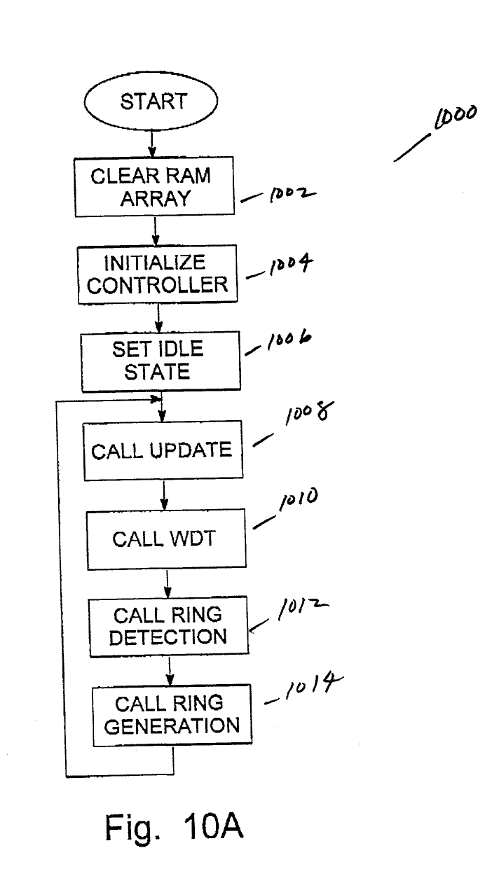

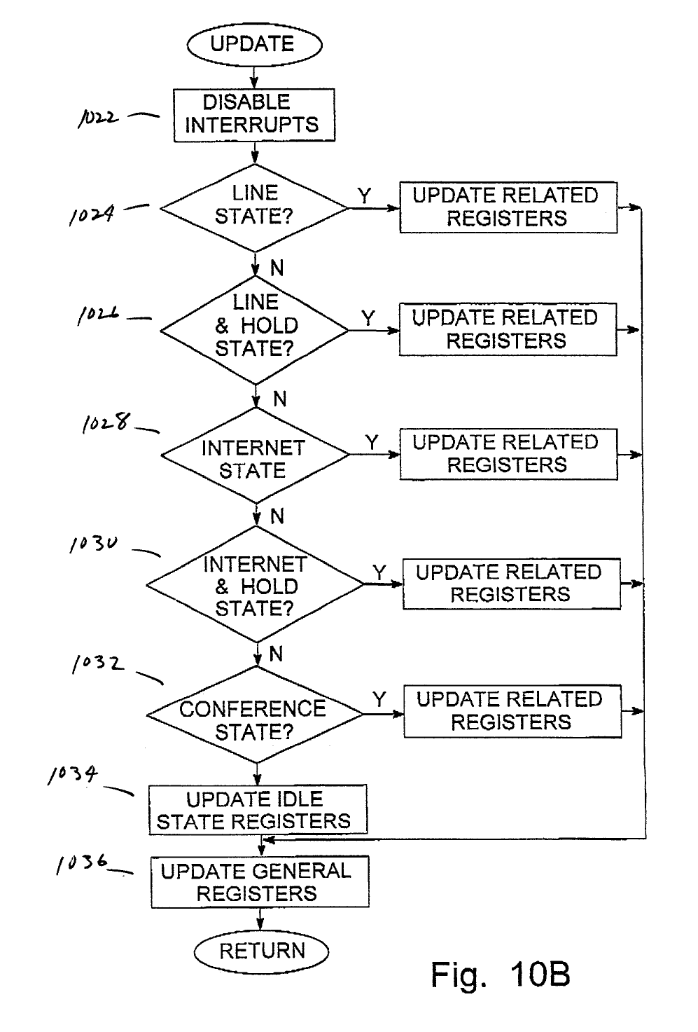

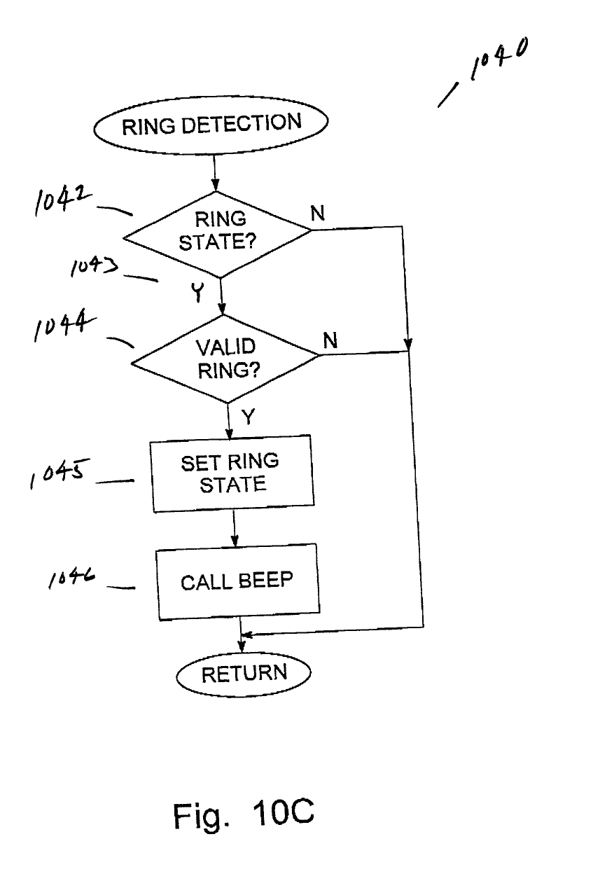

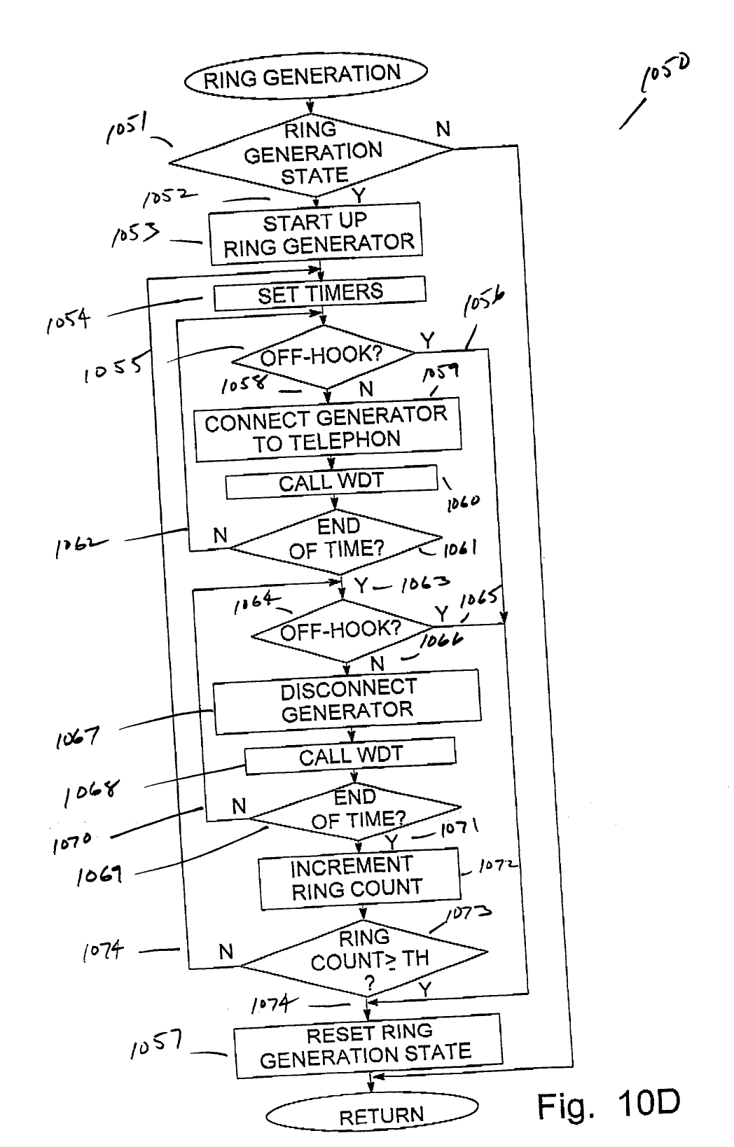

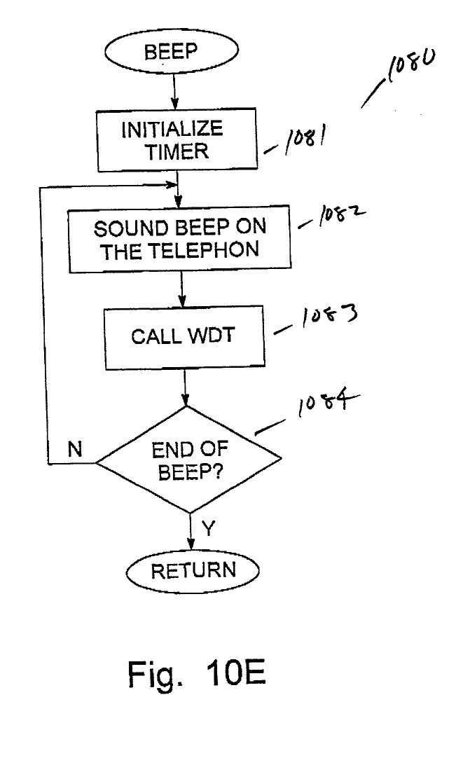

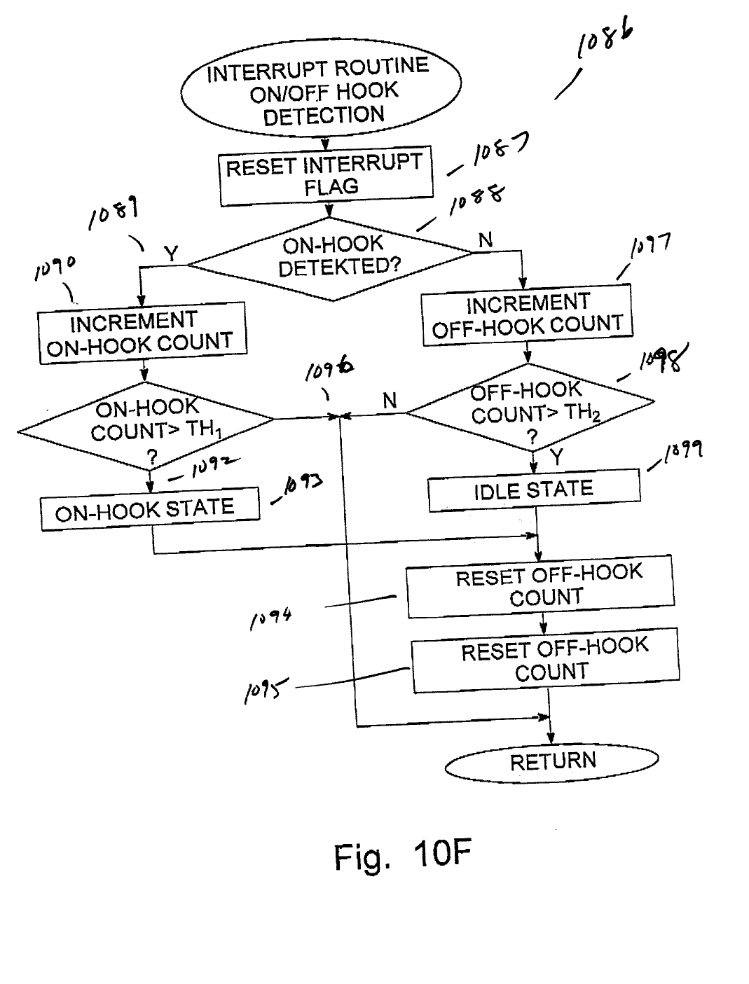

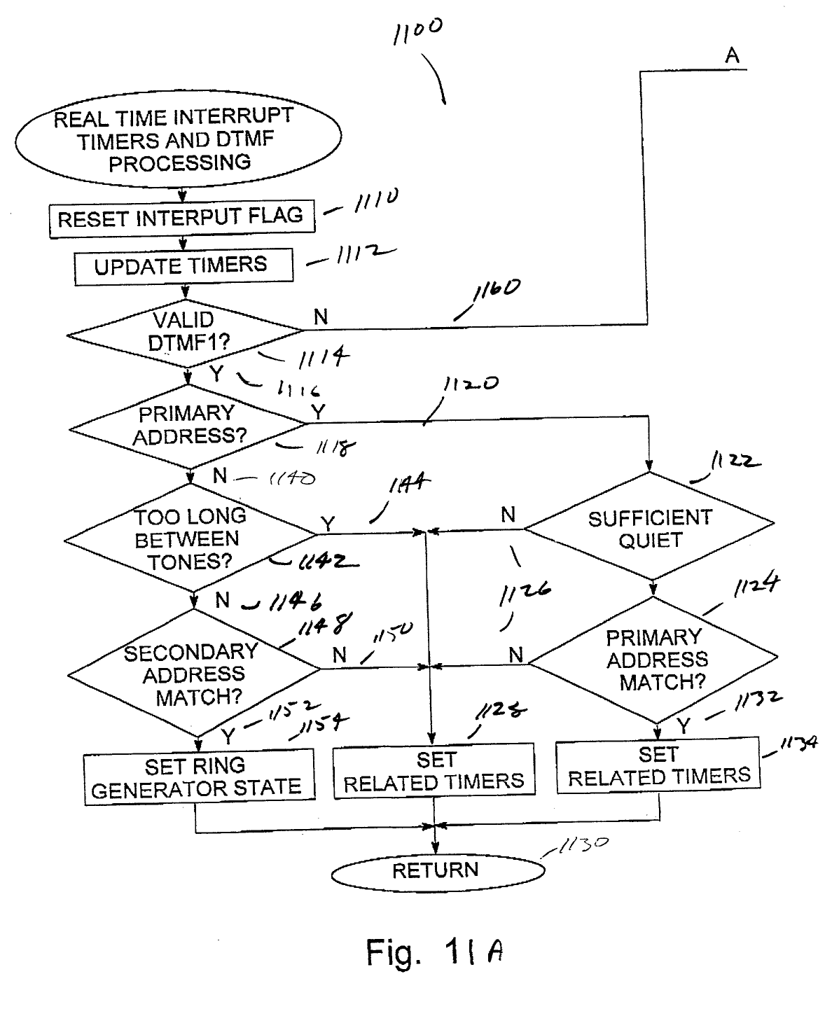

FIGS. 10A-I illustrate the various activities and functions of the system. FIG. 10A shows the zeroing procedure 1000 of the system. First the RAM array is cleared 1002. Then the controller is initialized 1004 and the idle state is set 1006. Then a loop for updating call status 1008, monitoring a timer 1010, detecting calls 1012 and generating a ring signal 1014 are cycled through.

FIG. 10B shows the update procedures for the various registers, as a function of the detection of the status of the communication line, e.g., whether on hold or conference status. First the interrupts are disabled 1022. Then the line state 1024, line and hold state 1026, Internet state 1028, Internet and hold state 1030 and conference state 1032 are updated. Thereafter, idle state registers are updated 1034. Finally, the general registers are updated 1036.

FIG. 10C shows the ring detection procedure 1040. First the ring state is checked 1042. If a ring is detected 1043, the validity of the ring is determined 1044. Then the ring state is set 1045. It should be noted that the “Set Ring Status” is activated by a timer. Then the “Call Beep” routine 1046 is activated by a call incoming from the second line, in a two (or more) lines system.

FIG. 10D shows the procedure for ring generation 1050. This procedure is followed each time a virtual ring is received from the Internet, and a real ring signal has to be transmitted to telephone apparatus.

First, the ring generation state is determined 1051. If ring for the Internet is detected 1052, the ring generation routine is initiated 1053. Timers are first set 1054 and the system determines whether an off-hook condition is detected 1055. If yes 1056, the ring generation state is reset 1057. Otherwise 1058, the ring generator is connected to the telephone 1059 and a watch dog timer is triggered 1060. The system determines whether an end of time has been detected 1061. If not 1062, the system recycles to the off-hook condition detection decision 1055. Otherwise 1064, the system proceeds to another loop phase.

In the second loop phase, a second off-hook decision 1064 is made. If the second off-hook condition is met 1065, the ring generation state is reset 1057. Otherwise 1066, the ring generator is disconnected 1067 and a watch dog timer is triggered 1068. The system determines whether an end of time has been detected 1069. If not 1070, the system recycles to reset the second off-hook condition detection decision 1064. Otherwise 1071, the ring count is incremented 1072. Then the ring count is compared to a threshold 1073. If the ring count is less than the threshold 1074, the system cycles to reset the timers 1054. Otherwise 1075, the ring generation state is reset 1057.

FIG. 10E shows the procedure 1080 used to provide a “beep” signal to the earphone. This is done so that the caller, e.g., through a web site, knows that his call has been transferred and the target telephone is ringing. This beep sound may be generated even before the ring signal is actually generated. First, a timer is initialized 1081. The beep sound is then initiated 1082 and a watch dog timer for controlling the duration is called 1083. Then the system determines whether the end of the beep sound occurs 1084.

FIG. 10F shows the routine 1086 that takes care of the on-hook/off-hook status, and which updates the relevant registers as a result of the current status. First, the interrupt flag is reset 1087. Then the system determines whether an on-hook status is detected 1088. If the on-hook status is detected 1089, the on-hook count is incremented 1090. The on-hook count is compared to a threshold 1091. If the on-hook count is less than the threshold 1092, the on-hook state is entered 1093 and the off-hook count 1094 and off-hook counts 1095 are reset. Otherwise 1096, the procedure recycles.

If the on-hook status is not detect, the off-hook count is incremented 1097. The off-hook count is compared to a threshold 1098. If the on-hook count is less than the threshold, the idle state 1099 is entered and the off-hook count 1094 and on-hook count 1095 are reset.

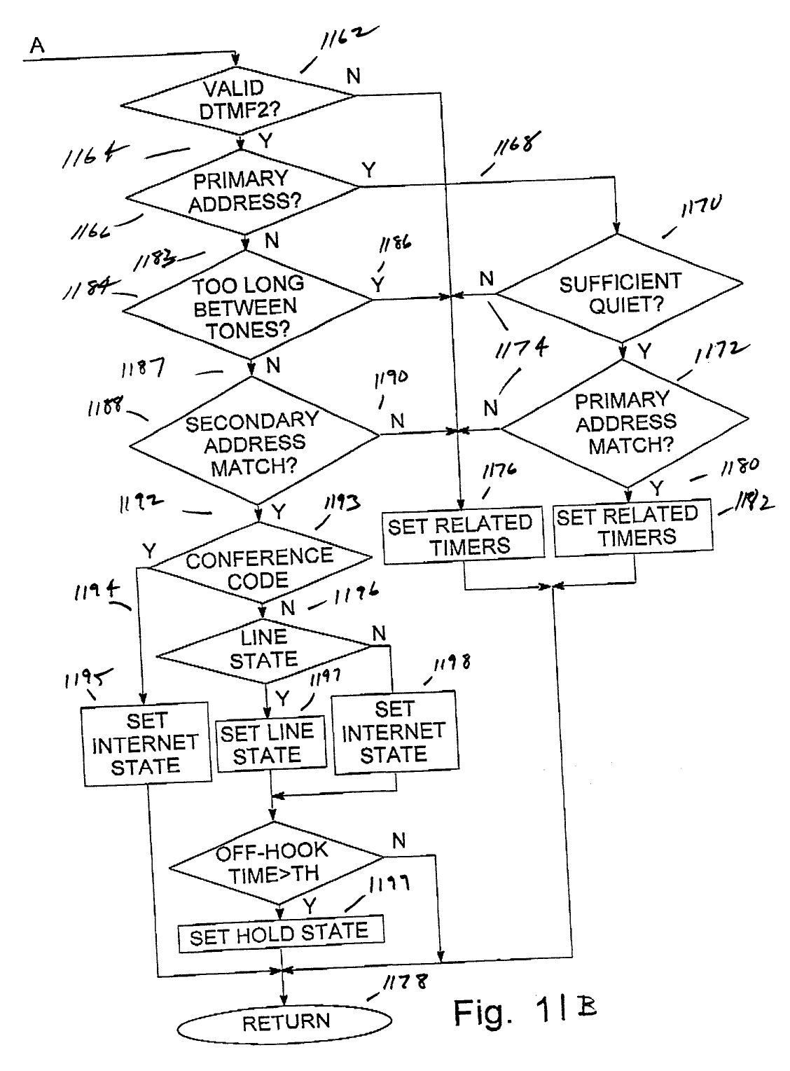

FIGS. 11A-11B detail a routine 1100 which analyzes the DTMF coming from either the telephone or the Internet, to determine whether it is the appropriate signal, and whether it is accompanied by noise. DTMF tone processing is implemented as a real time interrupt routine. There are two sources for DTMF tones: DTMF1 is from the Internet, and DTMF2 is from the telephones.

The first step performed is to reset interrupt flags 1110 and to update various timers 1112. The system then checks whether a valid tone was received 1114. If yes 1116, then the system determines whether the tone is the primary address. 1118. If the tone is the primary address 1120, then the system checks to see if there was sufficient quiet before the tone 1122. Then the system determines whether the tone matches the primary address 1124. If not 1126, related timers are updated 1128 and a return 1130 is performed. If the tone does match the primary address 1132, related timers are updated 1134 and the return 1130 is performed.

If the tone is the secondary address 1140, the system determine whether too much time has elapsed between primary and secondary tones 1142. If too much time has elapsed 1144 related timers are updated 1128 and the return 1130 is then performed. If too much time has not elapsed 1146, the system then determines whether the second tone matches the secondary address 1148. If there is no match 1150, related timers 1128 are updated and the return 1130 is performed. If there is match 1152, the ring generator state is entered 1154.

If the path is DTMF2 1160, the system then checks whether a valid tone was received 1162. If yes 1164, then the system determines whether the tone is the primary address 1166. If the tone is the primary address 1168, then the system checks to see if there was sufficient quiet before the tone 1170. Then the system determines whether the tone matches the primary address 1172. If not 1174, related timers are updated 1176 and a return 1178 is performed. If the tone does match the primary address 1180, related timers are updated 1182 and the return 1176 is performed.

If the tone is the secondary address 1183, the system determine whether too much time has elapsed between primary and secondary tones 1184. If too much time has elapsed 1186 related timers are updated 1176 and the return 1178 is then performed. If too much time has not elapsed 1187, the system then determines whether the second tone matches the secondary address 1188. If there is no match 1190, related timers 1176 are updated and the return 1178 is performed. If there is match 1192, the system then determines whether the code matches conference code 1193. If the code does match the conference code 1194, the Internet state is entered 1195. If not, the system switches between line 1197 and Internet 1198 states. If too much time has elapsed for off-hook state, hold state is entered 1198 and the return 1178 is performed. If not, the return is performed.

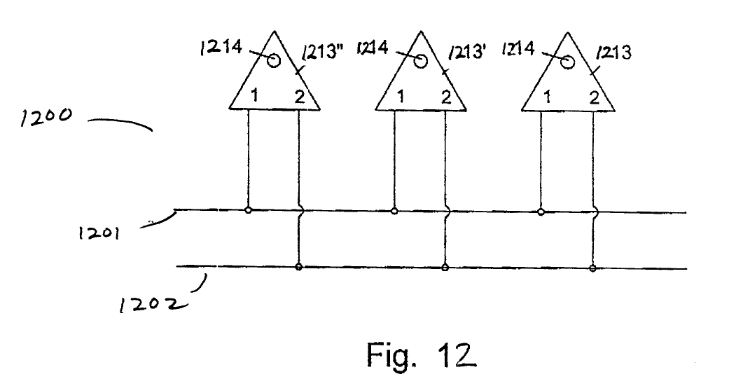

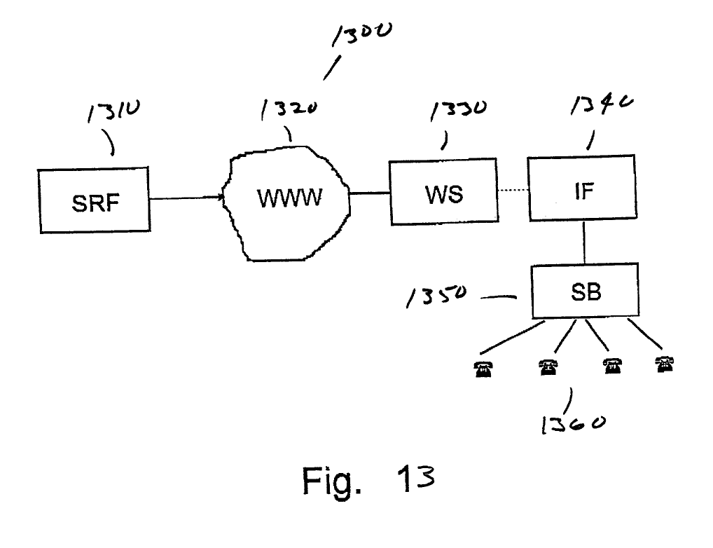

FIG. 12 shows a configuration 1200 in which a plurality of improved telephone apparatuses are connected in parallel on the same line, three such devices (1213, 1213′ and 1213″) being shown in the figure. Each improved telephone apparatus has two lines, 1201 and 1202, one of which is a regular telephone line, and the other a computer-originating line. A loudspeaker 1214 is also provided in each apparatus. This configuration enables not only all the functions described hereinbefore, but also makes it possible to send audio signals through the interface means of the telephone apparatus to loudspeaker 1214, for paging purposes.

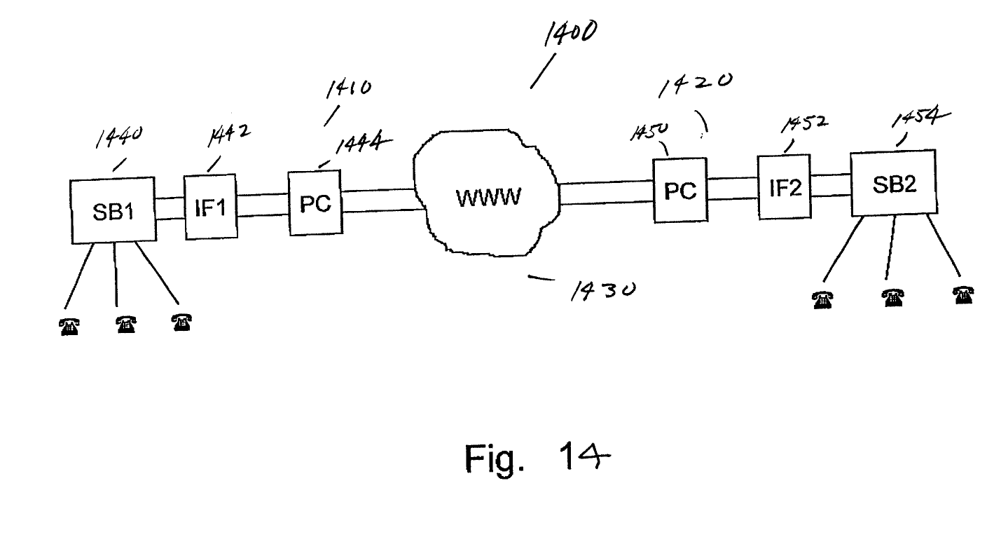

FIG. 13 illustrates a possible connection setup 1300 using the apparatus of the invention. According to this setup a surfer 1310 is connected through appropriate browsing means to the Internet 1320. The surfer 1310 reaches the web site WS 1330 of a target entity, which is connected to the switchboard SB 1350 of the organization via interface means IF 1340. In this configuration the surfer 1310 will be able to reach a predetermined telephone extension 1360, or the switchboard which will direct his call to the appropriate extension 1360.

FIG. 14 illustrates another setup 1400 utilizing the invention, which is suitable for communication between two organizations via the Internet or an intranet. In this option, two identical setups 1410, 1420 are provided at two extremities of the Internet 1430. A switchboard SB1 1440 is connected through an interface IF1 1442 and computer 1444 to the Internet (WWW) 1430. A call from SB! 1440 arrives at a second computer 1450. The second interface IF2 1552 translates the call for the second switchboard SB2 1554. This arrangement 1400 makes it possible for each extension of each switchboard to reach directly a desired extension of the other switchboard, through the Internet.

Many options can be allowed by the system of the invention. For instance, means can be provided for connecting a plurality of communication lines, to create a conference call, or for holding a second call while responding to a first call. Additionally, means can be provided for simulating dial tone, ringing tone and busy tones, or for generating a warning sound to alert a person conducting a telephone conversation, of a further incoming call. Many other options can be added, as will be apparent to the skilled person, which are understood by the man of the art and which, therefore, are not discussed herein in detail, for the sake of brevity.

Accordingly, an Internet-telephone interface adapter for creating telephone signals based upon input signals and for selectively coupling a microphone and speaker system with a telephone line and a computer using the created telephone signals based upon the source of the input signals has been disclosed.

The foregoing description of the exemplary embodiment of the invention has been presented for the purposes of illustration and description. It is not intended to be exhaustive or to limit the invention to the precise form disclosed. Many modifications and variations are possible in light of the above teaching. It is intended that the scope of the invention be limited not with this detailed description, but rather by the claims appended hereto.

What is claimed is:

1. A Internet-telephone interface, comprising an adapter for creating telephone signals based upon input signals, the adapter selectively coupling a microphone and speaker system with a telephone line and a computer using the created telephone signals based upon the source of the input signals.

2. The Internet-telephone interface of claim 1 wherein the input signals are from a telephone line and the adapter couples the microphone and speaker system to the telephone line.

3. The Internet-telephone interface of claim 1 wherein the input signals from the computer are signals from a sound device in the computer.

4. The Internet-telephone interface of claim 3 wherein the microphone and speaker system comprises a speaker and microphone coupled to the sound device.

5. The Internet-telephone interface of claim 3 wherein the adapter converts digital signals received via the Internet at the sound device to analog telephone signals.

6. The Internet-telephone interface of claim 1 wherein the input signals are from the computer and the adapter couples the microphone and speaker system to the computer.

7. The Internet-telephone interface of claim 1 wherein the microphone and speaker system comprises a telephone.

8. The Internet-telephone interface of claim 1 wherein the created telephone signal comprises a ring signal.

9. The Internet-telephone interface of claim 1 wherein the created telephone signal comprises a dial tone.

10. The Internet-telephone interface of claim 1 wherein the created telephone signal comprises a busy tone.

11. The Internet-telephone interface of claim 8 wherein the created telephone signals further comprise control signals for performing a call transfer.

12. The Internet-telephone interface of claim 11 wherein the control signals establish a virtual line for performing the call transfer.

13. The Internet-telephone interface of claim 11 wherein the created telephone signals further comprise a call waiting signal indicating an incoming call.

14. The Internet-telephone interface of claim 1 wherein the adapter further comprises a switch for switchably controlling a connection to the microphone and speaker system, wherein the connection comprises a first connection between the microphone and speaker system and the computer and a second connection between the microphone and speaker system and the telephone line.

15. The Internet-telephone interface of claim 14 wherein the adapter further comprises
a detector for detecting a call signal, said call signal being representative of a telephone apparatus trying to establish connection with the microphone and speaker system;
a telephone ring generator for generating a telephone ring signal for signaling the detection of the call signal; and
an off hook detector for detecting off hook status of the microphone and speaker system, wherein the switch connects the microphone and speaker system to the computer upon detection of the off hook status.

16. The Internet-telephone interface of claim 15 wherein the adapter further comprises a ringing signal generator for transmitting to a calling party a signal indicative that a called party has not answered the call while the off hook status is not detected.

17. The Internet-telephone interface of claim 15 wherein the detector for detecting a call signal further comprises a DTMF receiver, the DTMF receiver translating DTMF signals to digital signals for processing by the adapter.

18. The Internet-telephone interface of claim 1 wherein the adapter further comprises a conference call system for connecting a plurality of communications lines to create a conference call.

19. The Internet-telephone interface of claim 1 wherein the adapter further comprises a hold circuit for holding a first call while a second call is processed.

20. The Internet-telephone interface of claim 19 wherein the adapter further comprises an on-hold music circuit for generating music when a call is being held hold.

21. The Internet-telephone interface of claim 1 further comprising a microprocessor for controlling functions of the adapter.

22. A method for interfacing a microphone and speaker system with a telephone line and a computer so that normal telephone calls and Internet-based telephone calls can be processed, the method comprising the steps of:
creating telephone signals based upon input signals; and
selectively coupling a microphone and speaker system with a telephone line and a computer using the created telephone signals based upon the source of the input signals.

23. The method of claim 1 wherein the input signals are from a telephone line and the adapter couples the microphone and speaker system to the telephone line.

24. The method of claim 1 wherein the input signals from the computer are signals from a sound device in the computer.

25. The method of claim 24 wherein the microphone and speaker system comprises a speaker and microphone coupled to the sound device.

26. The method of claim 24 wherein the adapter converts digital signals received via the Internet at the sound device analog telephone signals.

27. The method of claim 22 wherein the input signals are from the computer and the adapter couples the microphone and speaker system to the computer.

28. The method of claim 22 wherein the microphone and speaker system comprises a telephone.

29. The method of claim 22 wherein the created telephone signals comprise a ring signal, a dial tone and a busy tone.

30. The method of claim 29 wherein the created telephone signals further comprise control signals for performing a call transfer.

31. The method of claim 30 wherein the control signals establish a virtual line for performing the call transfer.

32. The method of claim 30 wherein the created telephone signals further comprise a call waiting signal indicating an incoming call.

33. The method of claim 22 further comprises the step of switchably controlling a connection to the microphone and speaker system using a switch, wherein the connection comprises a first connection between the microphone and speaker system and the computer and a second connection between the microphone and speaker system and the telephone line.

34. The method of claim 33 wherein the step of creating telephone signals based upon input signals further comprises the steps of detecting a call signal, said call signal being representative of a telephone apparatus trying to establish connection with the microphone and speaker system, generating a telephone ring signal for signaling the detection of the call signal and detecting off hook status of the microphone and speaker system, wherein the switch connects the microphone and speaker system to the computer upon detection of the off hook status.

35. The method of claim 34 wherein the step of crating telephone signals based upon input signals further comprises the step of transmitting to a calling party a signal indicative that a called party has not answered the call while the off hook status is not detected.

36. The method of claim 34 wherein the step of detecting a call signal further comprises the step of translating DTMF signals to digital signals for processing by the adapter.

37. The method of claim 20 wherein the step of selectively coupling a microphone and speaker system with a telephone line and a computer using the created telephone signals based upon the source of the input signals further comprises the step of connecting a plurality of communications lines to create a conference call.

38. The method of claim 22 wherein the step of selectively coupling a microphone and speaker system with a telephone line and a computer using the created telephone signals based upon the source of the input signals further comprises the step of holding a first call while a second call is processed.

39. The method of claim 38 wherein the step of holding a first call while a second call is processed further comprises the step of generating music when a call is being held hold.
